(19) United States
(12) Patent Application Publication
(10) Pub. No.: US 2006/0190697 A1
(43) Pub. Date: Aug. 24, 2006

(54) A lock-free memory allocator with delayed coalescing

(76) Inventor: Calum A. Grant, Birmingham (GB)

Correspondence Address: Dr.Calum A Grant, 348 Sarehole Road, Hall Green, Birmigham, B28 0AQ, GB

(21) Appl. No.: 10/906,247

(22) Filed: Feb. 10, 2005

(51) Int. Cl. G06F 12/00

(52) U.S. Cl. 711/170

(57) ABSTRACT

A method is disclosed for dynamic memory allocation in computer programs. The invention uses free-lists stored in a table. A method of delayed coalescing is disclosed, whereby blocks are not coalesced immediately they are deallocated. Coalescing is performed by storing block-pointers in an array, sorting the array, and scanning the array for adjacent blocks. The memory allocator can operate in a completely lock-free way using atomic lists. The invention also contains thread-local caches of memory blocks, allowing it to operate mostly lock-free, and specific methods for allocating data and transferring data in between tables are disclosed. A method for automatic memory management (“garbage collection”) based on this allocator is also disclosed. The realisation of this algorithm is a faster memory allocation system for use by computer programs requiring either automatic or manual memory management.

### FIELD OF INVENTION

This invention relates to the way computers allocate memory to programs, and presents novel methods for making memory allocation faster.

### BACKGROUND

Memory management is an essential facility for all computer programs. Nowadays, almost half of the running time of software is spent on memory allocation, because modern object-oriented programming languages generate a lot of objects as they operate.

All programs operate on data, and the program needs to know where in memory it can use. A memory allocator is responsible for allocating the computer's memory to the program. At its basic level, a memory allocator provides two functions:
allocate—reserve a region of memory for exclusive use by the program
deallocate—notify the memory manager that the allocated memory is no longer needed by the program.

Higher-level languages, that create objects implicitly, still use a memory allocator underneath. Automatic memory management (“garbage collection”) uses additional algorithms to deallocate memory, so that a programmer does not need to deallocate memory explicitly.

How the memory allocator achieves this is a private matter for the memory allocator, however there are some key characteristics of memory allocators:
They should be efficient in their use of memory.
They should have low overheads.
They should exploit processor cache as much as possible.

### MOTIVATION FOR INVENTION

This invention aims to reduce the overheads of memory allocation.

In order to be efficient in their use of memory, memory allocators must be able to coalesce memory. This means that if lots of small blocks are freed, the allocator can coalesce them and allocate them as a single large block again. However, coalescing has overhead that slows down the allocator, and it turns out to be inefficient to do this too often.

When memory allocators are used in multi-threaded programs, they must be thread-safe, so that concurrent threads can allocate or deallocate memory at the same time. Usually this means using some kind of mutex (mutual exclusion) mechanism. However locking and unlocking a mutex adds an overhead that can have a big impact on the performance of the allocator. Thread-local storage is a mechanism whereby threads do not interfere with one another so expensive locking is not required.

### PRIOR ART

Memory management, or dynamic memory allocation, is a core algorithm in computer science. Knuth [1] describes the basic memory allocation techniques, which are
First-fit. The heap is organised as a list of used and free blocks or varying sizes. The list is searched sequentially until a free block is large enough for the request.
Best-fit. The heap is organised as a list of used and free blocks. The list of blocks is searched sequentially to find the location that best fits the required memory.
Buddy systems. The heap is subdivided by powers of two, like a binary tree. At each level is a doubly-linked list of available blocks. On allocation, larger blocks are split to provide smaller blocks, and on deallocation, smaller blocks are merged to become larger blocks.

A thorough review of modern memory managers has been written by Wilson et al. [2]. The current state of the art in terms of performance is the Kingsley Allocator [2] and the Lea allocator [3].

The Lea allocator [3] works by organising the heap into a list of chunks. Chunks may be marked as used or free. The Lea allocator uses binning to store lists of free blocks, and searches the bins in size order in order to find a chunk (block) that fits the request. The remainder of the chunk is marked as free. When a chunk is freed, it is coalesced with its neighbours immediately.

The Lea allocator discusses a number of potential optimizations, described as wilderness preservation, look-asides, deferred coalescing and pre-allocation. The description of the Lea allocator notes that the heuristics for deferred coalescing used by the algorithm tend to degrade performance. In other words, the Lea allocator has no good mechanisms for deferred coalescing at this time.

The Kingsley allocator [2] uses free-lists, and these lists store free blocks of sizes that are powers of two. Blocks are only ever split, so the critical drawback with this allocator is that the Kingsley allocator does no coalescing at all [2]. The lack of coalescing renders this allocator unsatisfactory for general use.

Many patents require memory management for their invention, and many use free-lists of blocks stored in tables. But they differ significantly from this invention in the way that they perform coalescing, and the algorithms used to manage blocks in thread-based tables.

### EXTERNAL REFERENCES

(1) Donald E. Knuth “The Art of Computer Programming Volume 1: Fundamental Algorithms,” 3^{rd} Edition, Addison Wesley 1995.
(2) Paul R. Wilson, Mark S. Johnstone, Micheal Neely, David Boles. “Dynamic Storage Allocation: A Survey and Critical Review” Lecture Notes in Computer Science 986 1-116, 1995,
(3) Maged M. Micheal “Scalable Lock-Free Dynamic Memory Allocation”, PLDI 2004 The 2004 ACM SIGPLAN Conference on Programming Language Design and Implementation, pages 35-46, June 2004.
(4) Description of the Lea allocator: http://gee.cs.oswego.edu/dl/html/malloc.html

### RELATED PATENTS

U.S. Pat. No. 5,109,336
U.S. Pat. No. 5,247,634
U.S. Pat. No. 5,339,411
U.S. Pat. No. 5,420,999
U.S. Pat. No. 5,623,654
U.S. Pat. No. 5,652,864
U.S. Pat. No. 5,657,790
U.S. Pat. No. 5,742,793
U.S. Pat. No. 5,835,959
U.S. Pat. No. 5,930,827
U.S. Pat. No. 6,070,202
U.S. Pat. No. 6,058,460
U.S. Pat. No. 6,112,222
U.S. Pat. No. 6,131,150
U.S. Pat. No. 6,422,661
U.S. Pat. No. 6,505,283
U.S. Pat. No. 6,507,903
U.S. Pat. No. 6,539,464
U.S. Pat. No. 6,757,802
U.S. Pat. No. 6,842,838
U.S. Pat. No. 6,842,901
U.S. Pat. No. 6,848,033
   Description of Data Structures

The memory manager 101 contains a free-list-table 102, as illustrated in FIG. 1.

The free-list table 102 is a fixed-size array. Each item in the array 102 is called a bin 103, that contains a pointer to a free-list 104, as illustrated in FIG. 2. A free-list 104 is a singly-linked list of blocks 105.

Each block 105 consists of a head 106 and free space 107, as illustrated in FIG. 3. The head 106 of the block has a fixed size, and contains a pointer to the next block 105 in the free-list 104.

The end of the list is marked by a NULL pointer stored in the head of the block 106. A bin 103 may be empty, in which case the bin 103 contains a NULL pointer.

Each free-list 104 contains blocks 105 of the same size. Each bin 103 has a designated block-size.

Allocation

Allocation is the process of allocating some memory to the calling program. The block of memory must be reserved by the memory manager so that is not allocated again.

Method 301: Determining the bin 103 A method size_to_bin 202 determines the bin number 103 for the given size. A converse method get_size 203 that determines the size of a particular bin 103 in a particular table 102.

When a binary binning strategy is used, method 202 use a fast integer logarithm implementation. Method 203 uses a shift operator.

Method 302: Allocating a bin 103 When the correct bin has been determined using the above method, the bin is checked to see whether there are any blocks 105 in the list.

If the bin 103 is not empty, the first block is removed from the list as shown in FIG. 3. The head of the list 3-X is assigned to the tail 3-B of the first block 3-A. The block 3-A is the block allocated.

If the bin 103 is empty, then larger blocks 105 must be split so that a block of the right size becomes available.

Method 303: Splitting blocks 105. FIG. 4 illustrates splitting a block using a binary splitting strategy. If the bin 4-X is empty, then the table 102 is searched for a bin containing a block 105 larger than the one requested. This is performed using a linear search down the table 102. When a non-empty bin 4-Y is found, the block 4-A in the bin is split as illustrated. Bin 4-Y is made to point to 4-B which is the tail of 4-A. The block 4-A is now split into blocks 4-C and 4-D, which occupy the memory previously used by 4-A. Because the block size of 4-X is known, the address of 4-D can be calculated. The list 4-X is set to 4-D, and the tail of 4-D is set to NULL.

The block 4-C is split repeatedly until a block of the desired size is created.

This method is not limited to just binary splitting. Other splitting strategies, including, but not limited to, geometric or Fibonacci splitting are anticipated by this invention.

Method 304: Requesting more memory. In the event that there are no larger blocks 105 to split, more virtual memory must be allocated from the operating system. An operating system call is used to acquire a new block 300, that is inserted into the table 102 in the correct bin 103. The allocated block 300 must be sufficiently large to meet the memory request. If the operating system fails to allocate a new block 300, allocation fails and the algorithm returns NULL.

A number of heuristics can be used for requesting memory 300 from the operating system. Memory of a fixed size can be requested, such as 1 MB blocks. The size of each request can be increased each time.

Method 305: Return value. When a free block 3-A of the correct size has been determined, and detached from the table 102, the head 106 of the free block 3-A is used to store the bin 3-X where the where the block 3-A was removed. This is used during deallocation to determine which bin 103 to use when returning the block. The flag 114 of the block is set to 1, meaning “allocated”.

If allocation from the operating system fails, allocation returns NULL.

Deallocation

Deallocation is when the client program indicates to the memory manager that the allocated memory is no longer required. The deallocated memory is then available for future allocation. Programs that fail to deallocate all their memory are said to “leak memory” and a leaky program can cause the system to eventually run out of available memory.

Method 306: Deallocation. FIG. 5 shows deallocation. When the calling program returns a free block 5-A, its bin number 5-X is read from the head 106 of the block.

The block 5-A is then inserted into the correct bin 5-X. The head 106 of block 5-A is set to 5-B, the old value of 5-X. The new value of 5-X is set to point to 5-A.

Coalescing

After many cycles of allocation and deallocation, the heap can become very fragmented. This means that the heap is full of lots of little blocks that have been split from larger ones. Unfortunately that means that these smaller blocks are unusable for larger blocks. The solution is to coalesce the heap. Coalescing involves combining adjacent free blocks into larger blocks.

Method 307: Heuristic for coalescing. A heuristic is used to determine when to coalesce the heap. Whilst other memory managers coalesce the heap on each deallocation, this invention coalesces the heap in batches. The heap can be coalesced after a certain number of bytes deallocated, after a certain number of deallocations, or both.

Coalescing can be prevented or triggered by the client program. The values used to trigger deallocation can be specified by the client program.

Coalescing by Walking the Heap

Method 308: The memory manager 101 can visit each block in the heap 113 as shown in FIG. 6. In order to do this, each block 105 must contain its bin number 103 in the head 106 of the block. Although allocated blocks store the bin number in their head 106, unallocated blocks 105 store a list pointer in the head.

So before coalescing takes place, each unallocated block 105 in the table 102 stores the bin number 103 in its head 106. The flag 114 in each unallocated block 105 is set to 0 meaning “unallocated”. The bins 103 in the table 102 are set to NULL.

The heap 113 can then be coalesced by moving a pointer along the heap, visiting each block in turn. The method bin_to_size 202 is used to compute the size of each block so that the address of the next block 105 can be computed.

When each block is visited, its flag 114 is checked. If the flag 114 has the value 1, it means that the block is allocated, and the block is skipped. If the flag 114 has value 0, it means that the block is free. Adjacent free blocks 105 are merged into larger blocks, and reinserted into the table 102.

Method 309: Integer representation There may not be a bin 103 of the right size to insert the unallocated block. In that case, the block must be split into smaller blocks that do have bins 103 in the table 102.

The algorithm for performing this depends upon the binning strategy. However if a binary binning strategy is used, the following method can be used.

The total size of the block is stored in an integer value. Because block sizes are powers of two, the bits in the integer indicate the blocks that need to be created and inserted into table 102.

Coalescing using an Array

Method 310: Coalescing. Each Each bin 103 in the table 102 is coalesced in turn, starting with the smallest bin, and finishing with the largest bin.

Method 311: Coalescing a bin. This is shown in FIG. 7.

The length of the list 104 is determined by traversing it, and an array 108 of that size is allocated. Array 108 can be allocated from the memory manager itself, but care must then be taken since then the start of the list 103, and the number of items in the list 104 may change.

The array 108 is filled with the addresses of the blocks 105 in the list 104, and then the array 108 is sorted using a standard array-sorting algorithm.

Adjacent blocks 105 are found by traversing the array 108, and comparing their addresses. Two adjacent blocks are combined into one, and pushed onto the list of blocks in the next bin. The remaining blocks are linked together to form a new list.

Newly coalesced blocks may be coalesced further when the next bin 103 is coalesced.

Method 312: Merge-sort. As a fall-back position, if no memory is available for allocating an array 108, then the list of blocks is sorted in-place using the standard merge-sort algorithm on linked lists. Sorting using merge-sort is slower, but this case will happen only very rarely.

Method 313: Recycling memory to the operating system. When a free block 105 is a block originally allocated from the operating system, the block can be removed from the data structure 101 completely and returned to the operating system.

Garbage Collection

When a mark-sweep garbage collector is used to automatically deallocate objects, the coalescing phase is synchronised to occur immediately after garbage-collection. Performance is increased by not coalescing on every collection, but only every few collections N, where N is a specifiable parameter. A value of N that works well is 5.

Method 314: Allocation A free block 105 is allocated using the allocation algorithm described above. A list of live blocks 109 is used to keep track of all objects allocated by the memory manager (note that the memory manager normally keeps track just of free blocks). In this case, the head 106 of the allocated object 302 contains: the bin number, flags 111, and a pointer 110 to the next live object. This requires 8 bytes on 32-bit computer architectures. The next live object 110 in the allocated object 302 points to the live objects list 109, and the live objects list 109 points to the new object 302. In this way, all live objects are reachable through this singly-linked list 109.

Method 315: Collection. When garbage collection is triggered (perhaps due to a certain number of bytes allocated), the live-object-list 109 is traversed marking the flags

111 on each live object to 0.

Then the root-set pushed onto an auxiliary stack 112, and the flags 111 of those objects are marked with a 1.

The reachable objects are found by popping pending objects from the stack, and finding new reachable objects (whose flags 111 are 0) onto the stack 112, and marking their flags 111 as 1. This process is repeated until all live objects have been reached and marked.

Then the allocated objects 109 are traversed, and objects whose flags 111 are 0 are cut from the linked list, and are deallocated.

Incremental and parallel schemes of garbage collection using this data structure are also anticipated by the invention.

Method 316: Design of the stack 112. The stack 112 consists of an array allocated from the data structure 101. If the stack 112 becomes full, another array is allocated, and linked to the original array. A number of arrays can be allocated and chained together into a doubly-linked list.

If an array cannot be allocated, then the stack is emptied and algorithm is restarted, leaving objects marked as before. This is slower, but the method will eventually finish with all reachable objects marked 1.

Mixing Automatic and Manual Memory Management

Method 317: Automatic and manual memory management can be used simultaneously. A program that needs some memory that is deallocated manually, is allocated a block 105 as normal, but the block 105 is not added to the list 109.

Concurrency

Method 318: The above algorithms can work in a parallel/multi-threaded environment by using a critical section (“mutex”) on the allocation/deallocation routines.

Coalescing can be performed incrementally by coalescing one bin at a time, thereby reducing the pause on each allocation.

Coalescing can be performed in a separate thread, by setting the bin 103 being coalesced to NULL. This ensures that during the time that the bin 103 is coalesced, the blocks 105 in the bin are not allocated. Allocations from that bin 103 during this time will have to split larger blocks.

Method 319 The algorithm can be run completely lock-free using an atomic list for each list of blocks 104 in the table 102. An atomic list performs push and pop operations atomically, which means that they do not need a mutual exclusion lock, which is in general faster.

Garbage collection can be parallelized and incrementalized using standard techniques. Because the memory manager does not relocate data, no synchronisation points are required with other threads.

Concurrency via Thread-Local Storage (TLS)

The allocation algorithms described above can be made to work more efficiently in a multi-threaded environment via thread-local storage. This mechanism means that each table 102 is local to a thread, such that that there is one table 102 per thread.

The challenge is in getting threads to share data in a lock-free way, for example when data is allocated on one thread but deallocated in another.

In addition to a table per thread 116, there is a central table 117 that is shared between all threads. There is a lock 118 that can be used to provide exclusive access to the central table.

Method 320: Allocation from TLS. When memory is requested, the bin for that memory request is computed using the size_to_bin function 202. If the thread-local table 116 contains a block 105 of that size, it is removed from the table 116 and allocated.

If the thread-local table 116 does not contain a block 105 of that size, the central table 117 is queried for the block. If the central table 117 contains a block 105 of the right size, and then a block 105 is removed from the central table 117.

If neither the central table 117 or the thread-local table 116 contain a block 105 of the right size, then the bins are searched sequentially until either the thread-local 116 or the central table 117 contains a block 105. The block 105 is then split using the procedure described in this invention, until a block 105 of the right size is available. When a block 105 is split, its constituents are inserted into the thread-local table 116.

Method 321: Deallocation into TLS When a block is deallocated, it is inserted back into the thread-local table 116 using the information in the head 106 of the block. Memory allocated from one thread can be inserted into the table of another thread.

Method 322: Moving memory to the central table. At periodic intervals, all of the blocks 105 in a thread-local table 116 are moved to the central table 117. This is to stop threads from hogging too much memory.

The interval at which moving takes place can be specified by the client program, perhaps by number of deallocations, number of bytes deallocated, time intervals, never or immediately.

Method 323: Coalescing The central table 117 can be coalesced periodically, just as in the single-table version. Thread-local tables 116 are not coalesced, they are simply returned to the central table 117 for coalescing.

Coalescing is performed using Method 311.

### LIST OF ENTITIES

101 Memory manager.

102 Free-list table.

103 Bin.

104 Free-list.

105 Block.

106 Head of block.

107 Free space in block.

108 Array used for sorting.

109 Live list for garbage collection.

110 Pointer to next live block.

111 Flags in an allocated object.

112 Stack of objects pending marking.

113 A memory heap.

114 Flag in memory block.

115 Integer bit-map used for coalescing blocks.

116 Thread-local table.

117 Central table.

118 Lock.

### DESCRIPTION OF FIGURES

FIG. 1: The memory manager 101.

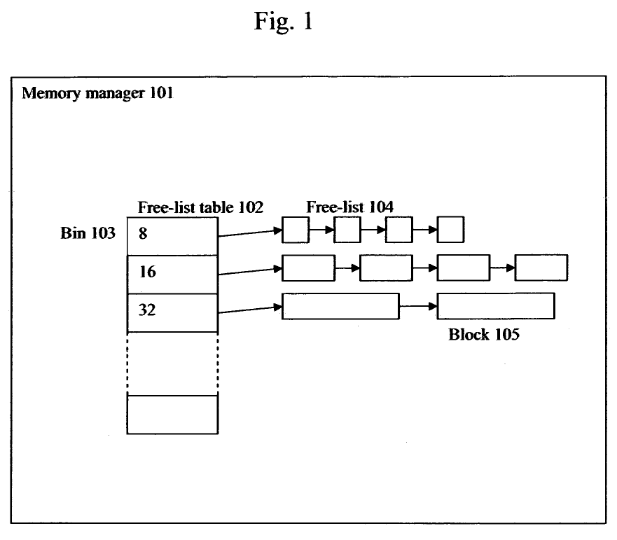

FIG. 2: A block 105.

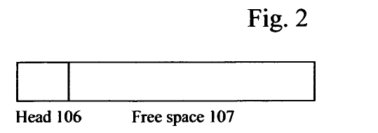

FIG. 3: Allocating a block. (a) The list before allocation. (b) The list after the first block has been removed.

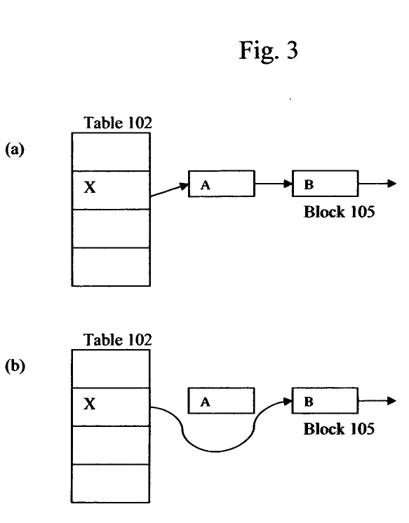

FIG. 4: Splitting a block. (a) The list before splitting. (b) Reorganising the pointers to create two smaller blocks. (c) The new data structure.

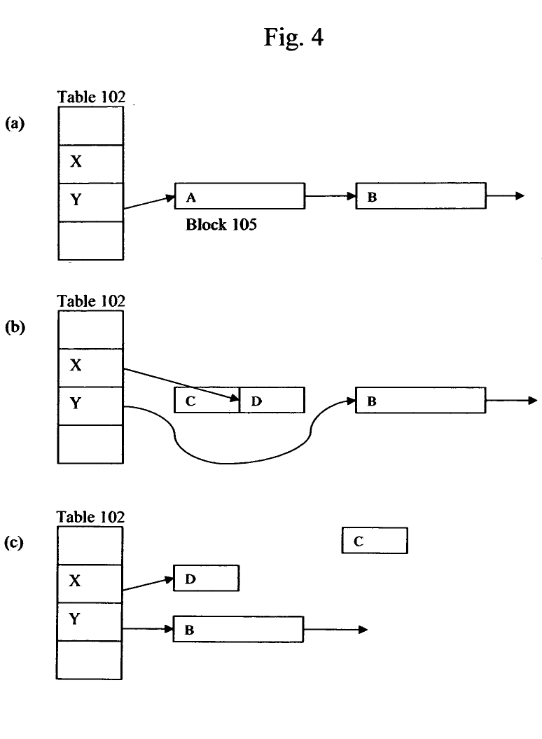

FIG. 5: Deallocating a block. (a) Before deallocation. (b) Inserting the deallocated block at the front of list.

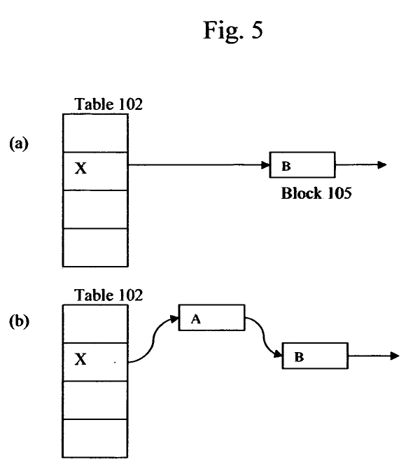

FIG. 6: Coalescing a memory heap 113. (a) The heap 113 before coalescing, (b) The heap 113 after coalescing.

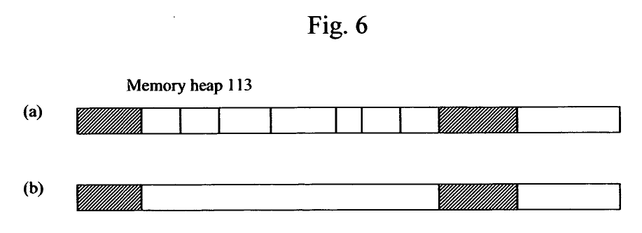

FIG. 7: Coalescing a list. (a) The initial list. (b) The items are moved into an array, (c) The array is sorted (d) Adjacent blocks are coalesced, and the remaining items are put back into the list. (e) The final data structure.

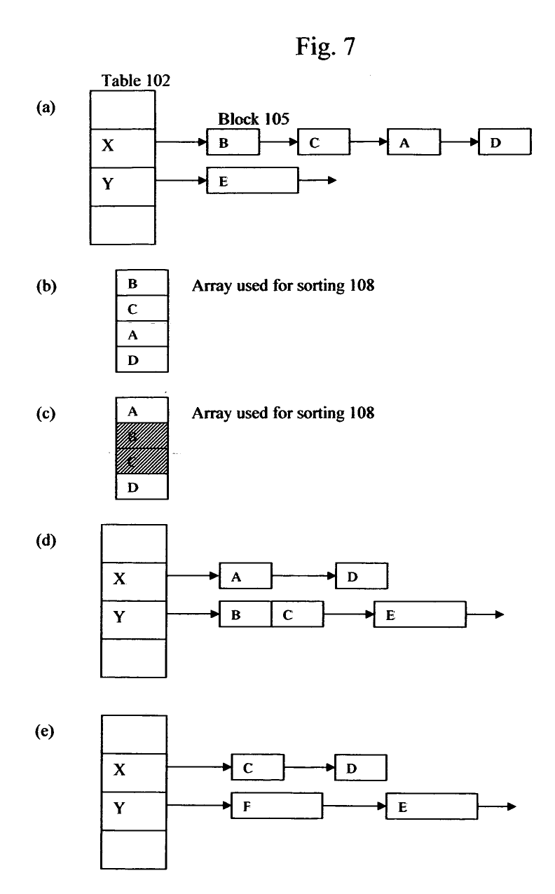

What is claimed is:

1. A computer data structure to organise free memory, that
maintains a table of pointers to free memory blocks of specified sizes,
maintains just one pointer per block,
has a configurable strategy for splitting and recombining memory blocks,
allows delayed coalescing.

2. A method that allows efficient allocation of free memory from the data structure in claim 1,
that splits memory blocks as required.

3. A method for inserting free memory into data structure of claim 1, allocated by the operating system.

4. A method that allows efficient deallocation of used memory (“recycling”) to the data structure described by claim 1,
such that the deallocation method does not perform coalescing on each deallocation.

5. Allowing the client program to specify coalescing
to preventing coalescing,
to coalesce immediately,
to specify that coalescing occurs after a given number of deallocations,
to specify that coalescing occurs after a given number of bytes deallocated,
to specify a time interval at which coalescing occurs.

6. A method of coalescing free blocks by walking the heap,
whereby coalescing is performed at specified intervals, not once per deallocation,
whereby any adjacent memory blocks can be combined, not just those from a block where they were initially split.

7. A method of coalescing free blocks using a sorting algorithm,
whereby coalescing is performed at specified intervals, not once per deallocation as per claim 4,
whereby the memory blocks to be sorted are inserted into an auxiliary array,
whereby the array can be allocated from the data structure of claim 1,
whereby merge-sort can be used to sort memory blocks,
whereby any adjacent memory blocks can be recombined, not just into the block from where they were initially split,
whereby the data structure in claim 1 can be reconstructed from the sorted array.

8. A system that uses a binary heap for the data structure in claim 1,
that uses a binary representation of an integer to compute how blocks can be coalesced.

9. A system implementing the data structures and methods claim 1-claim 8.

10. A method and system for automatic memory management (“garbage collection”) that interacts with data structure in claim 1 and system in claim 9,
that uses overheads of just 2 pointers per allocated object,
that triggers coalescing after garbage collection,
that triggers coalescing once every few collections,
that uses an auxiliary stack for marking allocated from data structure in claim 1,
that uses a stack combined from allocated blocks in data structure in claim 1.

11. A method for using claims 9 and 10 simultaneously for programs requiring both manual and automatic memory management.

12. A method for providing one data structure of claim 1 per concurrently
executing thread,
such that each thread has its own look-up table,
and there is a centralized look-up table.

13. A method for allocating memory from a thread-local data structure described by claim 12, whereby
memory is either allocated from the thread-local storage table (of claim 12) or from the central look-up table (of claim 12),
the central look-up table (of claim 12) can be queried in a non-locking way, and only locked when there is block present that can actually be extracted,
a method determines whether to allocate memory from the central table or the thread-local table,
memory blocks can be split from the central table (of claim 12), using the method of claim 12) into the thread-local table (of claim 12).

14. A method of moving memory blocks from thread-local storage (of claim 12) to central storage (of claim 12) at specified intervals,
heuristics for controlling that process, including the ability for the client program to specify that behaviour,
whereby coalescing of the central table (of claim 12) can be synchronised with the moving of blocks from thread-local to central storage.

15. Methods for performing incremental coalescing on data structure in claim 1, by coalescing one bin at a time.

16. Methods for performing concurrent coalescing on data structure in claim, by removing an entire list from a bin, processing it concurrently, then inserting the new data back into the data structure.

17. Methods for using and coalescing the data structure in claim 1 in multi-threaded programs in a completely lock-free way.
